(19) United States
(12) Patent Application Publication
(10) Pub. No.: US 2018/0187397 A1
(43) Pub. Date: Jul. 5, 2018

(54) PROJECTION TYPE DISPLAY DEVICE AND PROJECTION CONTROL METHOD

(71) Applicant: FUJIFILM Corporation, Tokyo (JP)

(72) Inventor: Koudai FUJITA, Saitama (JP)

(73) Assignee: FUJIFILM Corporation, Tokyo (JP)

(21) Appl. No.: 15/910,009

(22) Filed: Mar. 2, 2018

Related U.S. Application Data
(63) Continuation of application No. PCT/JP2016/074840, filed on Aug. 25, 2016.

(30) Foreign Application Priority Data
Sep. 25, 2015 (JP) 2015-188458

(51) Int. Cl. E02F 9/26; G02B 27/01; B60K 35/00; G09G 3/20; G09G 3/00; H04N 9/31

(52) U.S. Cl. CPC E02F 9/26; G02B 27/01; H04N 9/3155; G09G 3/20; G09G 3/003; B60K 35/00

(57) ABSTRACT

A projection type display device mounted in a construction machine having a windshield performs a first control for projecting image light onto a first projection range and stopping projection of image light onto a second projection range and a third projection range in a case where a bucket is detected on the first projection range on the windshield. Further, the projection type display device performs a second control for projecting image light onto each of the first projection range and the second projection range and stopping projection of image light onto the third projection range in a case where the bucket is detected at an overlapping position of the first projection range and the second projection range of the windshield.

### CROSS-REFERENCE TO RELATED APPLICATIONS

This application is a Continuation of PCT International Application No. PCT/JP2016/074840 filed on Aug. 25, 2016, which claims priority under 35 U.S.C § 119(a) to Japanese Patent Application No. 2015-188458 filed on Sep. 25, 2015. Each of the above application(s) is hereby expressly incorporated by reference, in its entirety, into the present application.

### BACKGROUND OF THE INVENTION

### 1. Field of the Invention

The present invention relates to a projection type display device and a projection control method.

### 2. Description of the Related Art

A head-up display (HUD) that projects, using a windshield of a vehicle including an automobile, a construction machine, or an agricultural machine, or a combiner disposed in the vicinity of the windshield as a screen, light onto the screen to display an image is known. According to the HUD, a user can make a driver visually recognize an image based on light projected from the HUD as a real image on the screen, or can make the driver visually recognize the image as a virtual image in front of the screen.

JP2012-071825A discloses an HUD for a construction machine. The HUD is configured so that a projection position of image light is movable so that a virtual image can be stably visually recognized by persons who get on the construction machine, having different lines of sight.

JP2009-173195A discloses an HUD for a construction machine. In a case where it is detected that the construction machine is in a position suitable for a high-place work, the HUD displays a virtual image at a higher portion of a windshield. Further, in a case where it is detected that the construction machine is in a position suitable for a low-place work, the HUD displays a virtual image at a lower portion of the windshield.

JP2002-146846A discloses an HUD that controls a projection position on the basis of the position of an arm or the like of a construction machine and a line of sight of an operator. The HUD is configured so that a virtual image can be visually recognized over a wide range by combining a semi-transparent spherical mirror having a sufficiently large size for covering a full visual field necessary for an operation of the operator and a projection unit that projects light onto the semi-transparent spherical mirror and has a variable projection direction.

JP2013-148901A discloses a display device in which a virtual image can be visually recognized over a wide range using three projection units that project image light.

JP2013-137355A discloses a display device in which a virtual image can be visually recognized over a wide range using two projection units that project image light. Respective projection ranges of image light of the two projection units are set to partially overlap each other.

### SUMMARY OF THE INVENTION

In a working machine such as a construction machine or an agricultural machine, movement of a line of sight of an operator is frequently performed, particularly, in a vertical direction, differently from a vehicle of which main purpose is transportation, such as an automobile. Further, a movement range of the line of sight of the operator in the vertical direction is wide differently from the vehicle of which main purpose is transportation. In addition, in the construction machine, the line of sight of the operator moves in accordance with movement of a power shovel or a bucket that is an operation target. In consideration of these points, in a working machine with a windshield in front of an operator's seat, it is preferable that an image such as a virtual image or a real image can be visually recognized over a wide range of the windshield.

According to the HUD disclosed in JP2002-146846A, it is possible to visually recognize an image over a wide range. However, it is difficult to perform optical design of the semi-transparent spherical mirror, and it is necessary to use a large semi-transparent spherical mirror. Further, it is necessary to use a mechanism for making a projection direction of image light in a projection unit movable. For these reasons, the manufacturing cost of the working machine becomes high.

Accordingly, as disclosed in JP2013-148901A and JP2013-137355A, in a case where a plurality of projection units is used, it is possible to reduce the manufacturing cost of the working machine. In the working machine, it is important to enhance fuel efficiency. However, in a case where the number of projection units increases, there is a concern that the fuel efficiency is badly affected. JP2013-148901A and JP2013-137355A do not recognize the problem of the improvement of the fuel efficiency in a case where a plurality of projection units is used.

Further, JP2012-071825A and JP2009-173195A do not consider a technique where a plurality of projection units is used.

Here, the working machine is described as an example, but even in an HUD mounted in a vehicle such as an automobile, an airplane, or a ship whose main purpose is transportation, there is a possibility that demand for visually recognizing an image over a wide range becomes high. In this case, as described above, since it is considered that it is effective to use a plurality of projection units, similar to the working machine, there is a concern that the fuel efficiency is badly affected.

The invention has been made in consideration of the above-mentioned problems, and an object of the invention is to provide a projection type display device and a projection control method capable of preventing increase in the manufacturing cost of a vehicle while visually recognizing an image over a wide range of a windshield of the vehicle, and enhancing the fuel efficiency of the vehicle.

According to an aspect of the invention, there is provided a projection type display device that includes a plurality of projection display units capable of spatially modulating light emitted from a light source on the basis of image information and projecting the spatially modulated image light onto a projection surface of a vehicle, in which respective projection ranges of image light of the plurality of projection display units are arranged in one direction, and an end of one projection range among two adjacent projection ranges in the one direction and the other projection range among the two projection ranges overlap each other. The projection type display device comprises: an object position detection unit that detects a position, on the projection surface, of an object in front of the projection surface; and a unit controller that controls each of the plurality of projection display units into any one of a first state where image light is to be projected or a second state where projection of image light is stopped, in which the unit controller controls each of the plurality of projection display units into any one of the first state or the second state on the basis of the position, in the one direction, of a first object detected by the object position detection unit, in which in a state where a first projection range that is an arbitrary projection range among the respective projection ranges of image light of the plurality of projection display units and the entirety of the first object detected by the object position detection unit overlap each other, the unit controller selectively performs any one of a first control or a second control on the basis of the position, in the one direction, of the first object in the first projection range, in which the first control is a control for controlling a first projection display unit capable of projecting image light onto the first projection range into the first state and controlling a projection display unit other than the first projection display unit into the second state, and in which the second control is a control for controlling the first projection display unit and a second projection display unit capable of projecting image light onto a projection range adjacent to the first projection range into the first state and controlling a projection display unit other than the first projection display unit and the second projection display unit into the second state.

According to another aspect of the invention, there is provided a projection control method using a plurality of projection display units capable of spatially modulating light emitted from a light source on the basis of image information and projecting the spatially modulated image light onto a projection surface of a vehicle, in which respective projection ranges of image light of the plurality of projection display units are arranged in one direction, and an end of one projection range among two adjacent projection ranges in the one direction and the other projection range among the two projection ranges overlap each other. The projection control method comprises: an object position detection step of detecting a position, on the projection surface, of an object in front of the projection surface; and a unit control step of controlling each of the plurality of projection display units into any one of a first state where image light is to be projected or a second state where projection of image light is stopped, in which the unit control step includes controlling each of the plurality of projection display units into any one of the first state or the second state on the basis of the position, in the one direction, of a first object detected in the object position detection step, in which the unit control step includes selectively performing any one of a first control or a second control on the basis of the position, in the one direction, of the first object in the first projection range in a state where a first projection range that is an arbitrary projection range among the respective projection ranges of image light of the plurality of projection display units and the entirety of the first object detected in the object position detection step overlap each other, in which the first control is a control for controlling a first projection display unit capable of projecting image light onto the first projection range into the first state and controlling a projection display unit other than the first projection display unit into the second state, and in which the second control is a control for controlling the first projection display unit and a second projection display unit capable of projecting image light onto a projection range among projection ranges adjacent to the first projection range into the first state and controlling a projection display unit other than the first projection display unit and the second projection display unit into the second state.

According to the invention, it is possible to provide a projection type display device and a projection control method capable of preventing increase in the manufacturing cost of a vehicle while visually recognizing an image over a wide range of a windshield of the vehicle, and enhancing the fuel efficiency of the vehicle.

### BRIEF DESCRIPTION OF THE DRAWINGS

FIG. 1 is a schematic diagram showing a schematic configuration of a construction machine 100 provided with an HUD 10 that is an embodiment of a projection type display device of the invention.

FIG. 2 is a diagram showing an example of a configuration inside an operator's cab in the construction machine 100 shown in FIG. 1.

FIG. 3 is a schematic diagram showing an internal configuration of a unit 2 that forms the HUD 10 shown in FIG. 1.

FIG. 4 is a schematic diagram showing an internal configuration of a unit 3 that forms the HUD 10 shown in FIG. 1.

FIG. 5 is a schematic diagram showing an internal configuration of a unit 4 that forms the HUD 10 shown in FIG. 1.

FIG. 6 is a schematic diagram illustrating an example of state transition of a range 5D set on a windshield 5.

FIG. 7 is a schematic diagram illustrating another example of state transition of the range 5D set on the windshield 5.

FIG. 8 is a schematic diagram illustrating still another example of state transition of the range 5D set on the windshield 5.

FIG. 9 is a schematic diagram illustrating a schematic configuration of a construction machine 100A that is a modification example of the construction machine 100 shown in FIG. 1.

FIG. 10 is a schematic diagram showing an internal configuration of a unit 2A of an HUD 10A mounted in the construction machine 100A shown in FIG. 9.

FIG. 11 is a schematic diagram illustrating an example of state transition of a range 5D in the HUD 10A.

### DESCRIPTION OF THE PREFERRED EMBODIMENTS

Hereinafter, embodiments of the invention will be described with reference to the accompanying drawings.

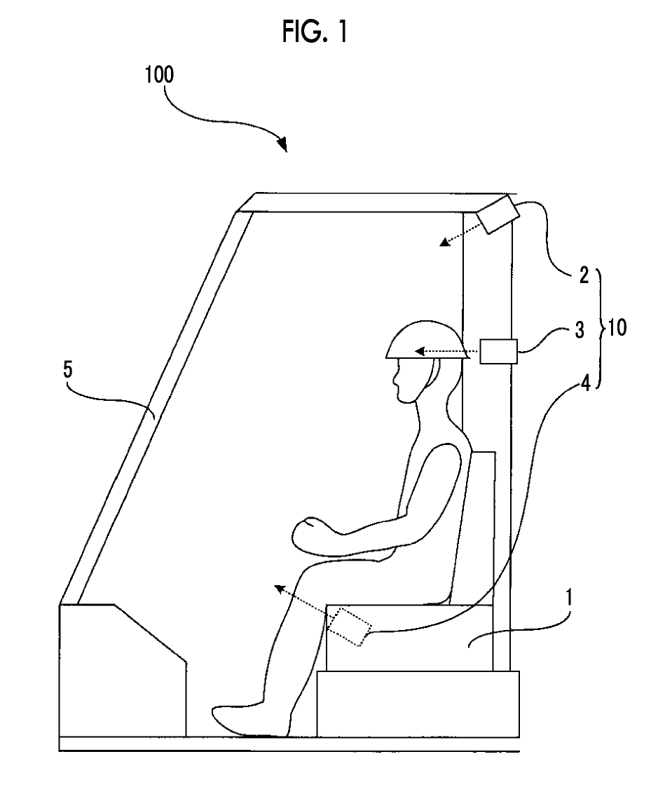

FIG. 1 is a schematic diagram showing a schematic configuration of a construction machine 100 provided with an HUD 10 that is an embodiment of a projection type display device of the invention.

The HUD 10 shown in FIG. 1 is mounted and used in a working machine such as a construction machine or an agricultural machine, a vehicle such as an automobile, an electric train, an airplane, or a ship, for example.

The HUD 10 includes a unit 2 that is provided on an upper side of an operator's seat 1 in an operator's cab, a unit 3 that is provided on a rear side of the operator's seat 1 in the operator's cab, and a unit 4 that is provided on a lower side a seat surface of the operator's seat 1 in the operator's cab.

The units 2 to 4 are provided to be spaced from each other in a gravity direction (a vertical direction in FIG. 1) in the operator's cab of the construction machine 100. Each unit projects image light under the condition that a virtual image is visually recognizable in front of a windshield 5 of the construction machine 100.

An operator of the construction machine 100 can visually recognize information on a picture, characters, or the like for assisting an operation of the construction machine 100 by viewing image light that is projected onto the windshield 5 and is reflected therefrom. Further, the windshield 5 has a function of reflecting image light projected from each of the units 2 to 4 and simultaneously transmitting light from the outside (an outside world). Thus, the operator can visually recognize a virtual image based on the image light projected from each of the units 2 to 4 in a state where the virtual image is superimposed on a scene of the outside world.

In the HUD 10, since the units 2 to 4 are provided to be spaced from each other in the gravity direction in the operator's cab of the construction machine 100, it is possible to present a virtual image to the operator over a wide range of the windshield 5.

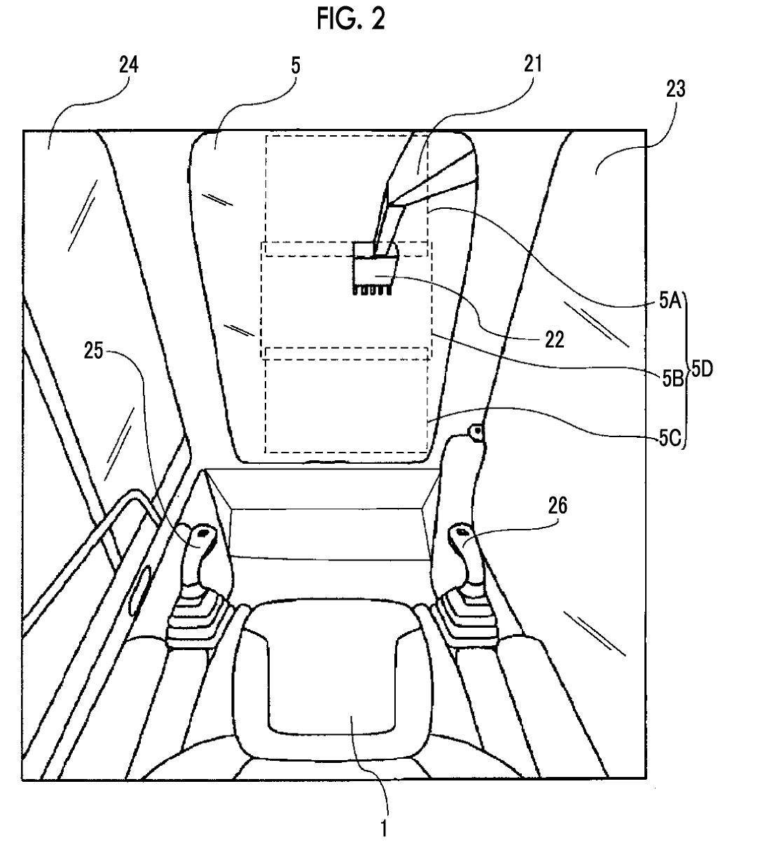

FIG. 2 is a diagram showing an example of a configuration inside the operator's cab of the construction machine 100 shown in FIG. 1. FIG. 2 is a front view in which the windshield 5 is seen from the operator's seat 1.

The construction machine 100 is a hydraulic shovel that includes an arm 21 and a bucket 22 that are movable parts capable of being moved in at least one direction (hereinafter, a vertical direction) in a front center of the machine. The construction machine 100 performs construction work through movement of the arm 21 and the bucket 22. As a construction machine that includes movable parts capable of being moved in one direction, a mini shovel, a bulldozer, a wheel loader, or the like may be used.

The operator's cab is surrounded by transparent windows such as the windshield 5 that is a front window, a right window 23, a left window 24, and the like. In the operator's cab, a left operating lever 25 for operating bending and stretching of the arm 21, a right operating lever 26 for operating digging and opening of the bucket 22, and the like are provided around the operator's seat 1.

Three projection ranges of a first projection range 5A, a second projection range 5B, and a third projection range 5C are allocated onto the windshield 5, and the projection ranges are arranged in the gravity direction (a vertical direction in FIG. 2). Here, a range 5D obtained by combining the three projection ranges forms a projection surface of the construction machine 100.

One end of one projection range among two adjacent projection ranges in the gravity direction among the three projection ranges overlaps the other projection range of the two projection ranges.

Specifically, in consideration of the first projection range 5A and the second projection range 5B that are adjacent to each other in the gravity direction, a lower end of the first projection range 5A in the gravity direction overlaps the second projection range 5B, and an upper end of the second projection range 5B in the gravity direction overlaps the first projection range 5A.

Further, in consideration of the second projection range 5B and the third projection range 5C that are adjacent to each other in the gravity direction, a lower end of the second projection range 5B in the gravity direction overlaps the third projection range 5C, and an upper end of the third projection range 5C in the gravity direction overlaps the second projection range 5B.

In the example of FIG. 2, the two adjacent projection ranges among the three projection ranges have end portions that overlap each other in the gravity direction, but a configuration in which one end, in the gravity direction, of one projection range among the two adjacent projection ranges among three projection ranges is contiguous to one end, in the gravity direction, of the other projection range among the two projection ranges may be used.

That is, in FIG. 2, a configuration in which the first projection range 5A, the second projection range 5B, and the third projection range 5C are arranged in the gravity direction without any gap, in other words, a configuration in which the lower end of the first projection range 5A is brought into contact with the upper end of the second projection range 5B and the lower end of the second projection range 5B is brought into contact with the upper end of the third projection range 5C may be used.

In this specification, in two projection ranges that are arranged in one direction, a configuration in which one end (edge) of one projection range in the one direction on the side of the other projection range and one end (edge) of the other projection range in the one direction on the side of the one projection range are brought into contact with each other is defined as a configuration in which one end of the one projection range overlaps the other projection range.

The first projection range 5A is a range where image light projected from the unit 2 is projected, which reflects the image light and simultaneously transmits light from the outside (outside world).

The second projection range 5B is a range where image light projected from the unit 3 is projected, which reflects the image light and simultaneously transmits light from the outside (outside world).

The third projection range 5C is a range where image light projected from the unit 4 is projected, which reflects the image light and simultaneously transmits light from the outside (outside world).

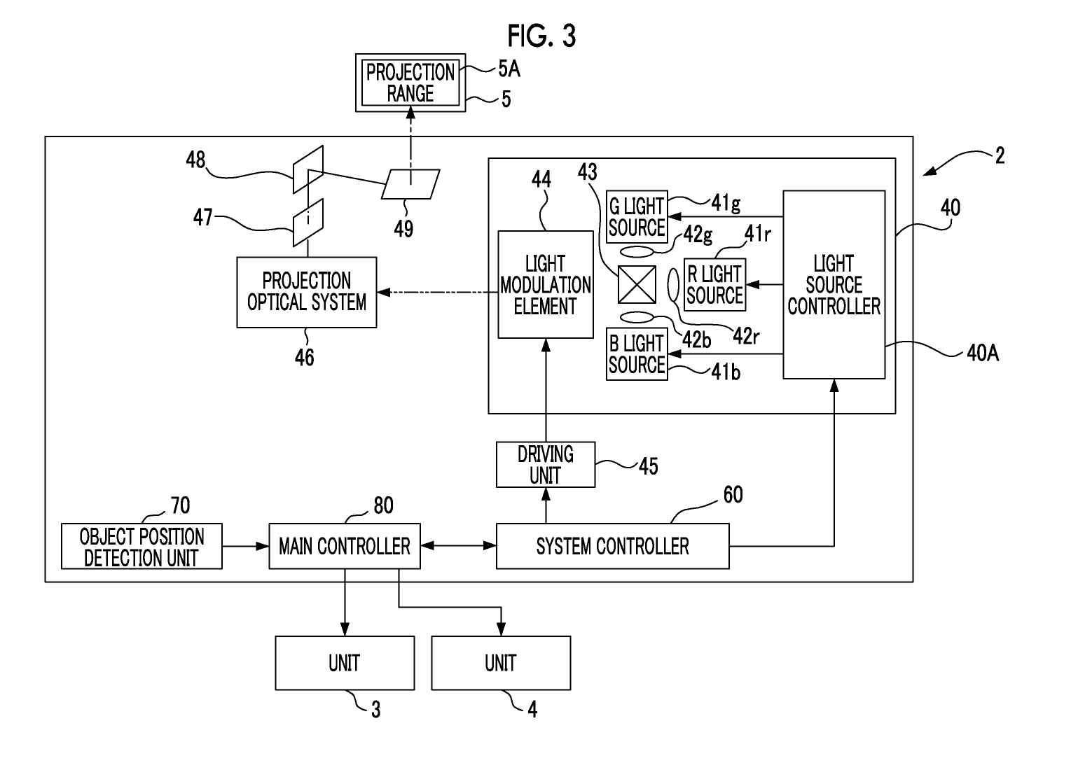

FIG. 3 is a schematic diagram showing an internal configuration of the unit 2 that forms the HUD 10 shown in FIG. 1.

The unit 2 includes a light source unit 40, a driving unit 45, a projection optical system 46, a diffuser plate 47, a reflecting mirror 48, a magnifying glass 49, a system controller 60 that controls the light source unit 40 and the driving unit 45, an object position detection unit 70, and a main controller 80.

The light source unit 40 includes a light source controller 40A, an R light source 41r that is a red light source that emits red light, a G light source 41g that is a green light source that emits green light, a B light source 41b that is a blue light source that emits blue light, a dichroic prism 43, a collimator lens 42r that is provided between the R light source 41r and the dichroic prism 43, a collimator lens 42g that is provided between the G light source 41g and the dichroic prism 43, a collimator lens 42b that is provided between the B light source 41b and the dichroic prism 43, and a light modulation element 44.

The dichroic prism 43 is an optical member for guiding light emitted from each of the R light source 41r, the G light source 41g, and the B light source 41b to the same optical path. That is, the dichroic prism 43 transmits red light that is collimated by the collimator lens 42r to be emitted to the light modulation element 44. Further, the dichroic prism 43 reflects green light that is collimated by the collimator lens 42g to be emitted to the light modulation element 44. Further, the dichroic prism 43 reflects blue light that is collimated by the collimator lens 42b to be emitted to the light modulation element 44. An optical member having such a function is not limited to a dichroic prism. For example, a cross dichroic mirror may be used.

The R light source 41r, the G light source 41g, and the B light source 41b respectively employ a light emitting element such as laser or a light emitting diode (LED). In this embodiment, an example in which the light sources of the light source unit 40 include three light sources of the R light source 41r, the G light source 41g, and the B light source 41b is shown, but the number of light sources may be 1, 2, 4 or more.

The light source controller 40A sets the amounts of luminescence of the R light source 41r, the G light source 41g, and the B light source 41b into predetermined luminescence amount patterns, and performs a control for sequentially emitting light from the R light source 41r, the G light source 41g, and the B light source 41b according to the luminescence amount patterns.

The light modulation element 44 spatially modulates light emitted from the dichroic prism 43 on the basis of image information, and emits light (red color image light, blue color image light, and green color image light) based on projection image data that is the image information to the projection optical system 46.

The light modulation element 44 may employ, for example, a liquid crystal on silicon (LCOS), a digital micromirror device (DMD), a micro electro mechanical systems (MEMS) element, a liquid crystal display device, or the like.

The driving unit 45 drives the light modulation element 44 according to projection image data input from the system controller 60, so that light (red color image light, blue color image light, and green color image light) based on the projection image data is emitted to the projection optical system 46.

The projection optical system 46 is an optical system for projecting light emitted from the light modulation element 44 of the light source unit 40 onto the diffuser plate 47. The optical system is not limited to a lens, and may employ a scanner. For example, the optical system may diffuse light emitted from a scanning-type scanner using the diffuser plate 47 to form a plane light source.

The reflecting mirror 48 reflects light diffused by the diffuser plate 47 toward the magnifying glass 49.

The magnifying glass 49 magnifies an image based on light reflected from the reflecting mirror 48, and projects the magnified image onto the first projection range 5A of the windshield 5.

The object position detection unit 70 detects the position, in the range 5D, of an object in front of the range 5D shown in FIG. 2 (in the example of FIG. 2, the bucket 22 that is a first object at the front center of the construction machine 100), and outputs information indicating the detected position of the object to the main controller 80.

As a method for detecting the object in front of the range 5D, for example, a first detecting method and a second detecting method to be described below may be used, but the invention is not limited to these methods.

(First Detecting Method)

An imaging unit that includes an imaging element is mounted in the construction machine 100, and image feature information of the bucket 22 at the front center of the construction machine 100 is set in advance. Further, the range 5D is imaged using the imaging unit, and matching based on the image feature information of the bucket 22 is performed with respect to captured image data obtained through the imaging to detect the position of the bucket 22 in the range 5D.

(Second Detecting Method)

Since the position of the bucket 22 is uniquely determined by operation signals of the left operating lever 25 and the right operating lever 26, the object position detection unit 70 detects the position of the bucket 22 in the range 5D on the basis of the operation signals for operating the left operating lever 25 and the right operating lever 26 in the construction machine 100.

In a case where an image light projection command is received from the main controller 80, the system controller 60 projects image light based on projection image data onto the first projection range 5A, and in a case where an image light projection stop command is received, the system controller 60 controls the light source unit 40 so that the light source unit 40 enters a stop or standby state, and stops the projection of the image light onto the first projection range 5A.

The main controller 80 generally controls the entirety of the HUD 10, and is capable of communicating with each of the units 3 and 4. A detailed function of the main controller 80 will be described later.

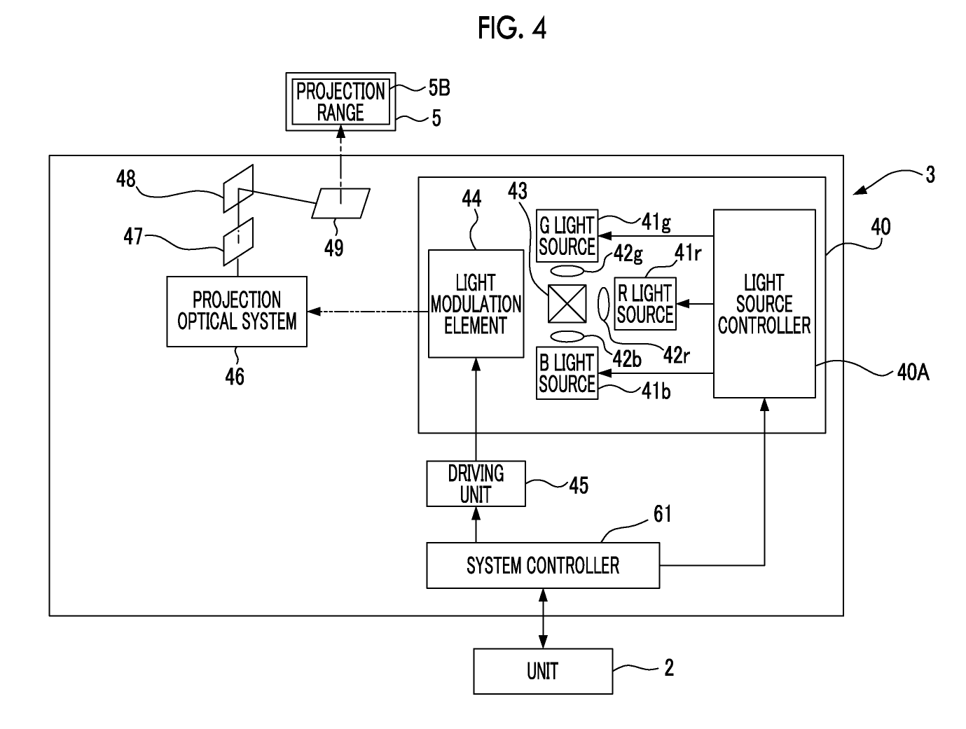

FIG. 4 is a schematic diagram showing an internal configuration of the unit 3 that forms the HUD 10 shown in FIG. 1. In FIG. 4, the same components as in FIG. 3 are given the same reference numerals.

The unit 3 has a configuration in which the object position detection unit 70 and the main controller 80 in the unit 2 shown in FIG. 3 are removed and the system controller 60 is modified into a system controller 61.

The system controller 61 of the unit 3 controls the driving unit 45 and the light source controller 40A in the unit 3, so that image light based on projection image data is projected onto the second projection range 5B.

The system controller 61 is able to communicate with the main controller 80 of the unit 2 in a wireless or wired manner, and projects image light based on projection image data received from the main controller 80 onto the second projection range 5B in a case where an image light projection command is received from the main controller 80. In a case where an image light projection stop command is received from the main controller 80, the system controller 61 controls the light source unit 40 so that the light source unit 40 enters a stop or standby state and stops the projection of the image light onto the second projection range 5B.

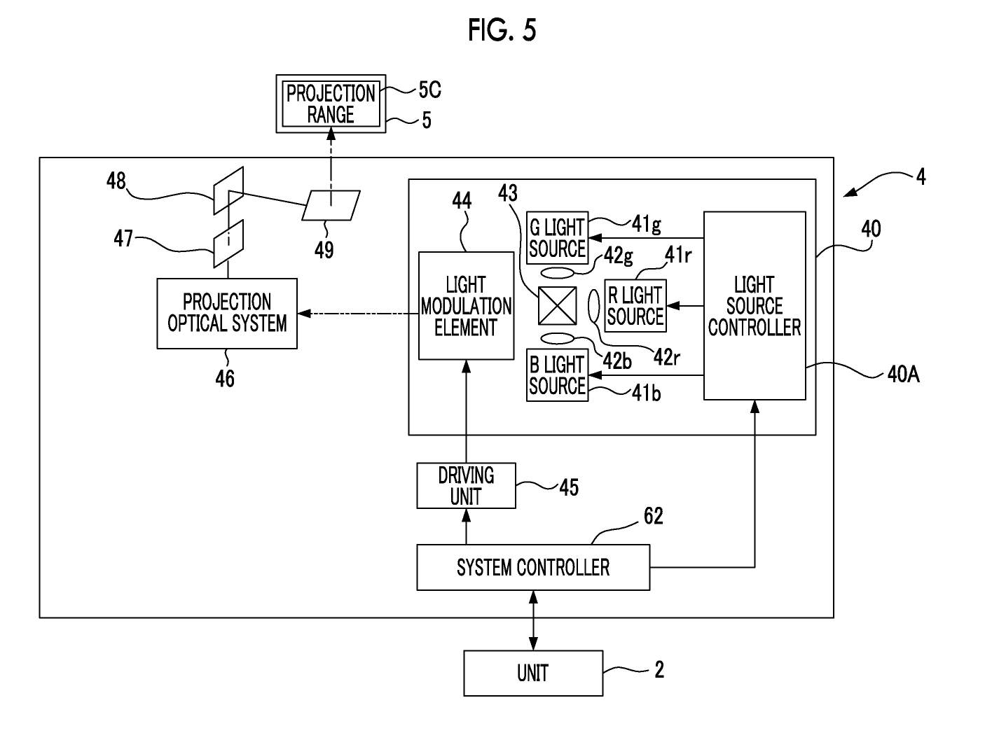

FIG. 5 is a schematic diagram showing an internal configuration of the unit 4 that forms the HUD 10 shown in FIG. 1. In FIG. 5, the same components as in FIG. 3 are given the same reference numerals.

The unit 4 has a configuration in which the object position detection unit 70 and the main controller 80 in the unit 2 shown in FIG. 3 are removed and the system controller 60 is modified into a system controller 62.

The system controller 62 of the unit 4 controls the driving unit 45 and the light source controller 40A in the unit 4, so that an image light based on projection image data is projected onto the third projection range 5C.

The system controller 62 is able to communicate with the main controller 80 of the unit 2 in a wireless or wired manner, and projects image light based on projection image data received from the main controller 80 onto the third projection range 5C in a case where an image light projection command is received from the main controller 80. In a case where an image light projection stop command is received from the main controller 80, the system controller 62 controls the light source unit 40 so that the light source unit 40 enters a stop or standby state and stops the projection of the image light onto the third projection range 5C.

The light source unit 40, the projection optical system 46, the diffuser plate 47, the reflecting mirror 48, and the magnifying glass 49 in the unit 2 form a projection display unit that projects image light based on projection image data onto the first projection range 5A.

The light source unit 40, the projection optical system 46, the diffuser plate 47, the reflecting mirror 48, and the magnifying glass 49 in the unit 3 form a projection display unit that projects image light based on the projection image data onto the second projection range 5B.

The light source unit 40, the projection optical system 46, the diffuser plate 47, the reflecting mirror 48, and the magnifying glass 49 in the unit 4 form a projection display unit that projects image light based on the projection image data onto the third projection range 5C.

The main controller 80 generates projection image data to be transmitted to the system controller 60, the system controller 61, and the system controller 62. The projection image data includes work assisting data such as an icon, characters, or the like for assisting work with respect to an operator of the construction machine 100.

In the construction machine 100, basically, the operator performs an operation while viewing the vicinity of the bucket 22. Accordingly, concentration of information to be presented to the operator on the vicinity of the bucket 22 causes a small movement of a line of sight, which is preferable.

Thus, the main controller 80 generates projection image data for displaying an icon or characters for assisting work around the bucket 22 on the basis of the position of the bucket 22 detected by the object position detection unit 70.

The projection image data is generated to be divided into projection image data corresponding to the first projection range 5A, projection image data corresponding to the second projection range 5B, and projection image data corresponding to the third projection range 5C.

Data corresponding to an overlapping range of the first projection range 5A and the second projection range 5B is included as the same data in the projection image data corresponding to the first projection range 5A and the projection image data corresponding to the second projection range 5B. Data corresponding to an overlapping range of the second projection range 5B and the third projection range 5C is included as the same data in the projection image data corresponding to the second projection range 5B and the projection image data corresponding to the third projection range 5C.

Further, the main controller 80 controls each of the three projection display units into any one state among a first state where image light is to be projected (hereinafter, referred to as a projection-on-state) or a second state where projection of image light is stopped (hereinafter, referred to as a projection-off-state) on the basis of the position, in one direction (vertical direction in FIG. 2) in the range 5D, of the object (bucket 22) in front of the range 5D detected by the object position detection unit 70. The main controller 80 forms a unit controller.

Specifically, in a state where a first projection range that is an arbitrary projection range among projection ranges of image light based on the respective three projection display units and the entirety of the object detected by the object position detection unit 70 overlap each other, the main controller 80 selectively performs any one of the first control or the second control on the basis of the position, in the one direction, of the object in the first projection range.

The first control is a control for setting the first projection display unit that projects image light onto the first projection range to the projection-on-state, and setting projection display units other than the first projection display unit to the projection-off-state.

The second control is a control for setting the first projection display unit and the second projection display unit that projects image light onto a projection range adjacent to the first projection range to the projection-on-state, and setting a projection unit other than the first projection display unit and the second projection display unit to the projection-off-state.

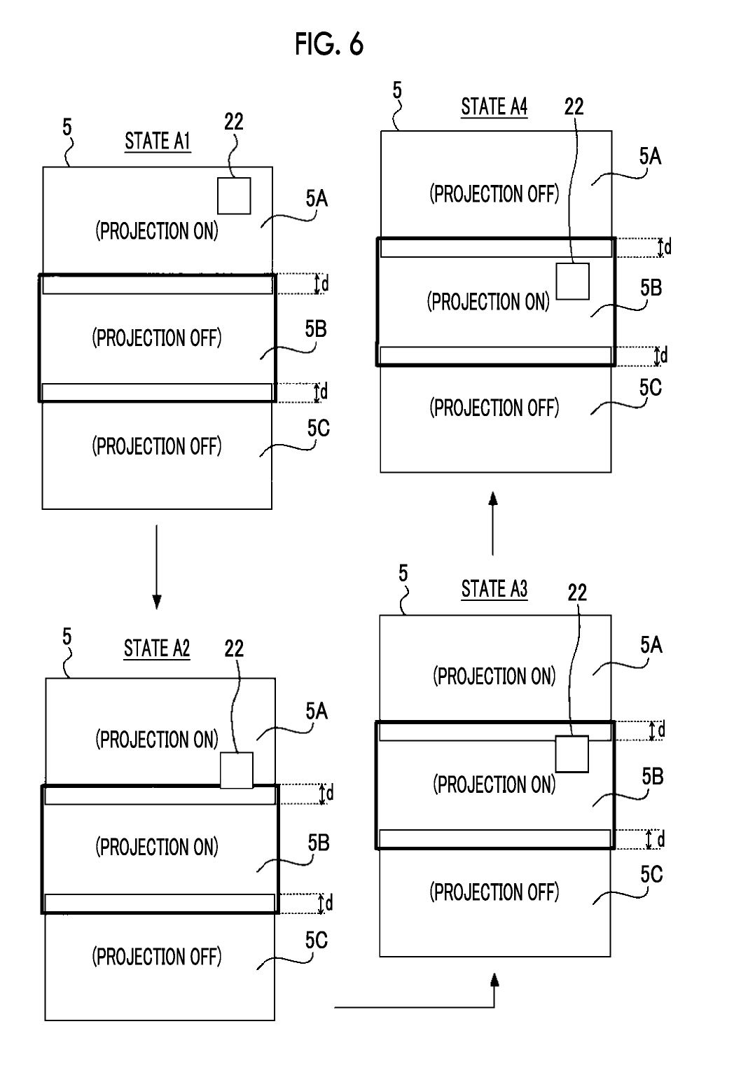

Specific examples of the first control and the second control performed by the main controller 80 will be described with reference to FIGS. 6 to 8.

FIG. 6 is a schematic diagram illustrating state transition of the range 5D set on the windshield 5.

In the range 5D, end portions of the first projection range 5A and the second projection range 5B that are adjacent to each other overlap each other, and end portions of the second projection range 5B and the third projection range 5C that are adjacent to each other overlap each other.

In FIG. 6, a range where the first projection range 5A and the second projection range 5B overlap each other and a range where the second projection range 5B and the third projection range 5C overlap each other are respectively represented as an overlapping range d.

The overlapping range d of the first projection range 5A and the second projection range 5B is a range corresponding to a predetermined distance from the lower end of the first projection range 5A in the gravity direction. The overlapping range d of the first projection range 5A and the second projection range 5B is a range corresponding to a predetermined distance from the upper end of the second projection range 5B in the gravity direction.

The overlapping range d of the second projection range 5B and the third projection range 5C is a range corresponding to a predetermined distance from the lower end of the second projection range 5B in the gravity direction. Further, the overlapping range d of the second projection range 5B and the third projection range 5C is a range corresponding to a predetermined distance from the upper end of the third projection range 5C in the gravity direction. In a case where a display size of each of the first projection range 5A, the second projection range 5B, and the third projection range 5C is 25 inches (55 cm×31 cm), it is preferable that the predetermined distance is in a range of 1 cm to 10 cm. In a case where the display size of each of the first projection range 5A, the second projection range 5B, and the third projection range 5C is larger or smaller than 25 inches, it is preferable that the predetermined distance becomes large or small according to the display size.

In FIG. 6, “(projection on)” and “(projection off)” are displayed in the respective projection ranges. A projection range where “(projection on)” is written represents a state where a projection display unit that projects image light onto the projection range is operated and projection of image light is performed. A projection range where “(projection off)” is written represents a state where a projection display unit that projects image light onto the projection range enters a stop or a standby state and projection of image light is stopped.

In a state A1, in a case where the position of the bucket 22 is detected by the object position detection unit 70, the main controller 80 determines that the entirety of the bucket 22 and the first projection range 5A overlap each other on the basis of the position and the bucket 22 is present out of the overlapping range d of the first projection range 5A and the second projection range 5B. Further, in this state, the main controller 80 performs a first control for controlling the projection display unit of the unit 2 into the projection-on-state and controlling the respective projection display units of the units 3 and 4 into the projection-off-state.

In a case where the bucket 22 moves downward from the state A1 to enter a state A2, the main controller 80 determines that the entirety of the bucket 22 and the first projection range 5A overlap each other on the basis of the position of the bucket 22 detected by the object position detection unit 70 and the bucket 22 overlaps the overlapping range d of the first projection range 5A and the second projection range 5B. In this state, the main controller 80 performs a second control for controlling the projection display units of the units 2 and 3 into the projection-on-state and controlling the projection display unit of the unit 4 into the projection-off-state.

In a case where the bucket 22 moves downward to enter a state A3, the main controller 80 determines that the entirety of the bucket 22 and the second projection range 5B overlap each other on the basis of the position of the bucket 22 detected by the object position detection unit 70 and the bucket 22 overlaps the overlapping range d of the first projection range 5A and the second projection range 5B. In this state, the main controller 80 performs a second control for controlling the projection display units of the units 2 and 3 into the projection-on-state and controlling the projection display unit of the unit 4 into the projection-off-state.

Further, in a case where the bucket 22 moves downward to enter a state A4, the main controller 80 determines that the entirety of the bucket 22 and the second projection range 5B overlap each other on the basis of the position of the bucket 22 detected by the object position detection unit 70 and the bucket 22 is present out of the overlapping range d of the first projection range 5A and the second projection range 5B, and the overlapping range d of the second projection range 5B and the third projection range 5C. In this state, the main controller 80 performs a first control for controlling the projection display unit of the unit 3 to the projection-on-state, and controlling the projection display units of the units 2 and 4 to the projection-off-state.

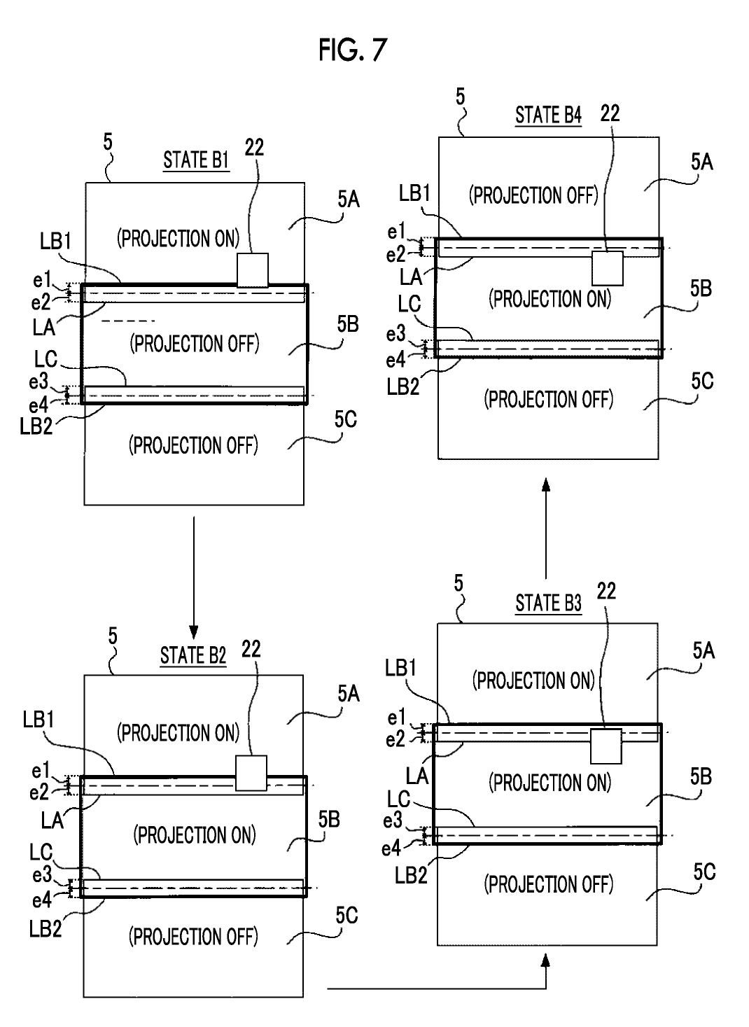

FIG. 7 is a schematic diagram illustrating another example of state transition of the range 5D set on the windshield 5.

The configuration of the range 5D in FIG. 7 is the same as that in FIG. 6, but in the first projection range 5A, a range corresponding to a predetermined distance from a lower end LA in the gravity direction is represented as a threshold value range e2. Further, in the second projection range 5B, a range corresponding to a predetermined distance from an upper end LB1 in the gravity direction is represented as a threshold value range e1. Further, in the second projection range 5B, a range corresponding to a predetermined distance from a lower end LB2 in the gravity direction is represented as a threshold value range e4. Further, in the third projection range 5C, a range corresponding to a predetermined distance from an upper end LC in the gravity direction is represented as a threshold value range e3.

All of the predetermined distances in FIG. 7 have the same value, and a range obtained by combining the threshold value range e1 and the threshold value range e2 is the same as the overlapping range of the first projection range 5A and the second projection range 5B. Similarly, a range obtained by combining the threshold value range e3 and the threshold value range e4 is the same as the overlapping range of the second projection range 5B and the third projection range 5C.

In a state B1, in a case where the position of the bucket 22 is detected by the object position detection unit 70, the main controller 80 determines that the entirety of the bucket 22 and the first projection range 5A overlap each other on the basis of the position and the bucket 22 is present out of the threshold value range e2 in the first projection range 5A. In this state, the main controller 80 performs a first control for controlling the projection display unit of the unit 2 into the projection-on-state and controlling the projection display units of the units 3 and 4 into the projection-off-state.

In a case where the bucket 22 moves downward to enter a state B2 from the state B1, the main controller 80 determines that the entirety of the bucket 22 and the first projection range 5A overlap each other on the basis of the position of the bucket 22 detected by the object position detection unit 70 and the bucket 22 overlaps the threshold value range e2 of the first projection range 5A. In this state, the main controller 80 performs a second control for controlling the projection display units of the units 2 and 3 into the projection-on-state and controlling the projection display unit of the unit 4 into the projection-off-state.

In a case where the bucket 22 moves downward to enter a state B3, the main controller 80 determines that the entirety of the bucket 22 and the second projection range 5B overlap each other on the basis of the position of the bucket 22 detected by the object position detection unit 70 and the bucket 22 overlaps the threshold value range e1 of the second projection range 5B. In this state, the main controller 80 performs a second control for controlling the projection display units of the units 2 and 3 into the projection-on-state and controlling the projection display unit of the unit 4 into the projection-off-state.

Further, in a case where the bucket 22 moves downward to enter a state B4, the main controller 80 determines that the entirety of the bucket 22 and the second projection range 5B overlap each other on the basis of the position of the bucket 22 detected by the object position detection unit 70 and the bucket 22 is present out of the threshold value range e1 and the threshold value range e4 of the second projection range 5B. In this state, the main controller 80 performs a first control for controlling the projection display unit of the unit 3 into the projection-on-state and controlling the projection display units of the units 2 and 4 into the projection-off-state.

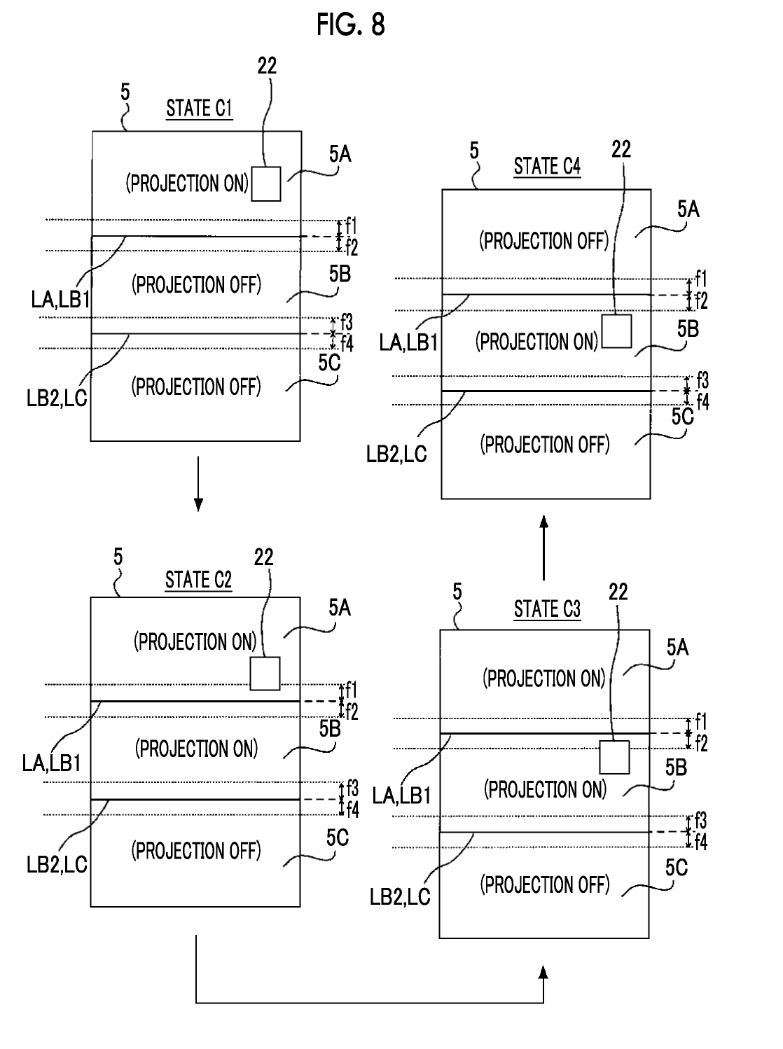

FIG. 8 is a schematic diagram illustrating still another example of state transition of the range 5D set on the windshield 5. In FIG. 8, an example in which a lower end LA of the first projection range 5A is brought into contact with an upper end LB1 of the second projection range 5B and a lower end LB2 of the second projection range 5B is brought into contact with an upper end LC of the third projection range 5C is shown.

Further, in FIG. 8, in the first projection range 5A, a range corresponding to a predetermined distance from the lower end LA in the gravity direction is represented as a threshold value range f1. Further, in the second projection range 5B, a range corresponding to a predetermined distance from the upper end LB1 in the gravity direction is represented as a threshold value range f2. Further, in the second projection range 5B, a range corresponding to a predetermined distance from the lower end LB2 in the gravity direction is represented as a threshold value range f3. Further, in the third projection range 5C, a range corresponding to a predetermined distance from the upper end LC in the gravity direction is represented as a threshold value range f4. The distances of the threshold value ranges f1 to f4 in the gravity direction are the same.

In a state C1, in a case where the position of the bucket 22 is detected by the object position detection unit 70, the main controller 80 determines that the entirety of the bucket 22 and the first projection range 5A overlap each other on the basis of the position and the bucket 22 is present out of the threshold value range f1 in the first projection range 5A. In this state, the main controller 80 performs a first control for controlling the projection display unit of the unit 2 into the projection-on-state and controlling the projection display units of the units 3 and 4 into the projection-off-state.

In a case where the bucket 22 moves downward to enter a state C2 from the state C1, the main controller 80 determines that the entirety of the bucket 22 and the first projection range 5A overlap each other on the basis of the position of the bucket 22 detected by the object position detection unit 70 and the bucket 22 overlaps the threshold value range f1 of the first projection range 5A. In this state, the main controller 80 performs a second control for controlling the projection display units of the units 2 and 3 into the projection-on-state and controlling the projection display unit of the unit 4 into the projection-off-state.

In a case where the bucket 22 moves downward to enter a state C3, the main controller 80 determines that the entirety of the bucket 22 and the second projection range 5B overlap each other on the basis of the position of the bucket 22 detected by the object position detection unit 70 and the bucket 22 overlaps the threshold value range f2 of the second projection range 5B. In this state, the main controller 80 performs a second control for controlling the projection display units of the units 2 and 3 into the projection-on-state and controlling the projection display unit of the unit 4 into the projection-off-state.

Further, in a case where the bucket 22 moves downward to enter a state C4, the main controller 80 determines that the entirety of the bucket 22 and the second projection range 5B overlap each other on the basis of the position of the bucket 22 detected by the object position detection unit 70 and the bucket 22 is present out of the threshold value range f2 and the threshold value range f3 of the second projection range 5B. In this state, the main controller 80 performs a first control for controlling the projection display unit of the unit 3 into the projection-on-state and controlling the projection display units of the units 2 and 4 into the projection-off-state.

As shown in FIGS. 6 to 8, in a state where the entirety of the bucket 22 enters an arbitrary projection range, the main controller 80 does not control only the projection display unit corresponding to the projection range into the projection-on-state, but also controls a projection display unit corresponding to a projection range adjacent to the arbitrary projection range into the projection-on-state according to the position of the bucket 22 in the arbitrary projection range.

For example, as indicated by the state A1 shown in FIG. 6, in a case where the bucket 22 is spaced from the lower end of the first projection range 5A at a certain distance, since only the projection display unit corresponding to the first projection range 5A is operated, it is possible to reduce power consumption of the entirety of the HUD 10.

On the other hand, as indicated by the state A2 shown in FIG. 6, in a case where the bucket 22 is present at a position close to the lower end of the first projection range 5A, the projection display unit corresponding to the second projection range 5B adjacent to the first projection range 5A in addition to the projection display unit corresponding to the first projection range 5A is also operated.

A configuration in which when the bucket 22 further moves downward in the state A2 shown in FIG. 6 and a lower end of the bucket 22 is out of the first projection range 5A, the projection display unit corresponding to the second projection range 5B adjacent to the first projection range 5A is operated may be considered.

However, in this method, there is a possibility that information displayed around the bucket 22 is instantly disturbed due to a time lag until the projection display unit corresponding to the second projection range 5B is started or returns from a standby state to project image light. For example, in a case where an icon is displayed in the vicinity of the lower end of the bucket 22, the icon instantly disappears, and then is displayed again.

According to the HUD 10, when the lower end of the bucket 22 comes to a position that is slightly before the lower end of the first projection range 5A, the projection display unit corresponding to the second projection range 5B is started or returns from the standby state.

Thus, for example, in a case where an icon is displayed in the vicinity of the lower end of the bucket 22, the icon is displayed by image light projected from the unit 2 and image light projected from the unit 3, respectively. Further, even in a case where the icon moves further downward to follow the bucket 22, while an upper end of the bucket 22 is present in the overlapping range d, the projection display unit corresponding to the first projection range 5A is operated. Thus, even in a case where an icon is displayed in the vicinity of the upper end of the bucket 22, it is possible to display the icon all the time, and to preferably perform working assistance.

In this way, according to the HUD 10, it is possible to realize energy saving by operating each of three projection display units only when necessary. Further, it is possible to prevent a situation where information for working assistance goes out of sight, to thereby advantageously perform working assistance.

Further, according to the HUD 10, since it is possible to visually recognize a virtual image over a wide range using three projection display units, it is possible to prevent increase in the manufacturing cost of the HUD 10, compared with a configuration in which a virtual image is visually recognizable over a wide range by one projection display unit using a semi-transparent spherical mirror.

Further, according to the HUD 10, since it is possible to project image light over a wide range of the windshield 5, even in a case where movement of a line of sight of an operator in a vertical direction becomes large according to movement of a bucket or the like that is an operation target, it is possible to perform sufficient working assistance for the operator.

In the above description, the number of projection ranges set on the windshield 5 is three, but it is sufficient if the number of projection ranges is plural. For example, a configuration in which the unit 4 is removed in the HUD 10 may be used.

In addition, in the above description, the plurality of projection ranges set on the windshield 5 is arranged in the gravity direction (vertical direction), but the plurality of projection ranges set on the windshield 5 may be arranged in a direction (lateral direction) orthogonal to the gravity direction. In this case, a configuration in which units that project image light onto respective projection ranges are provided to be spaced from each other in the lateral direction in the operator's cab of the construction machine 100 may be used.

In the above description, the object position detection unit 70 and the main controller 80 are provided in the unit 2, but a configuration in which a control unit that includes the object position detection unit 70 and the main controller 80 is provided as a separate body and the control unit generally controls the system controllers of the units 2 to 4 may be used.

Furthermore, in the above description, all of the units 2 to 4 are configured to project image light under the condition that a virtual image is visually recognizable, but at least one of units 2 to 4 may be configured to project image light under the condition that a real image is be visually recognizable.

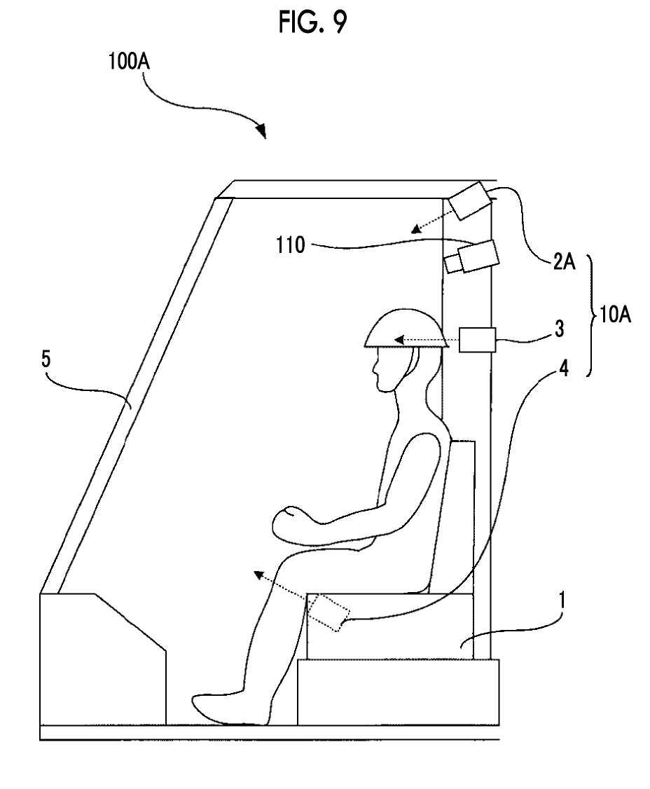

FIG. 9 is a schematic diagram showing a schematic configuration of a construction machine 100A that is a modification example of the construction machine 100 shown in FIG. 1. In FIG. 9, the same components as in FIG. 1 are given the same reference numerals, and description thereof will not be repeated.

In the construction machine 100A shown in FIG. 9, in addition to the configuration of the construction machine 100, an imaging unit 110 that images a subject using an imaging element is provided above an operator of the construction machine 100. Further, the HUD 10 is modified to an HUD 10A. The HUD 10A has a configuration in which the unit 2 is modified to a unit 2A in the HUD 10.

The imaging unit 110 images a range including the range 5D of the windshield 5. The imaging unit 110 is connected to the unit 2A that forms the HUD 10A in a wireless or wired manner, and transmits captured image data obtained by imaging the subject to the unit 2A.

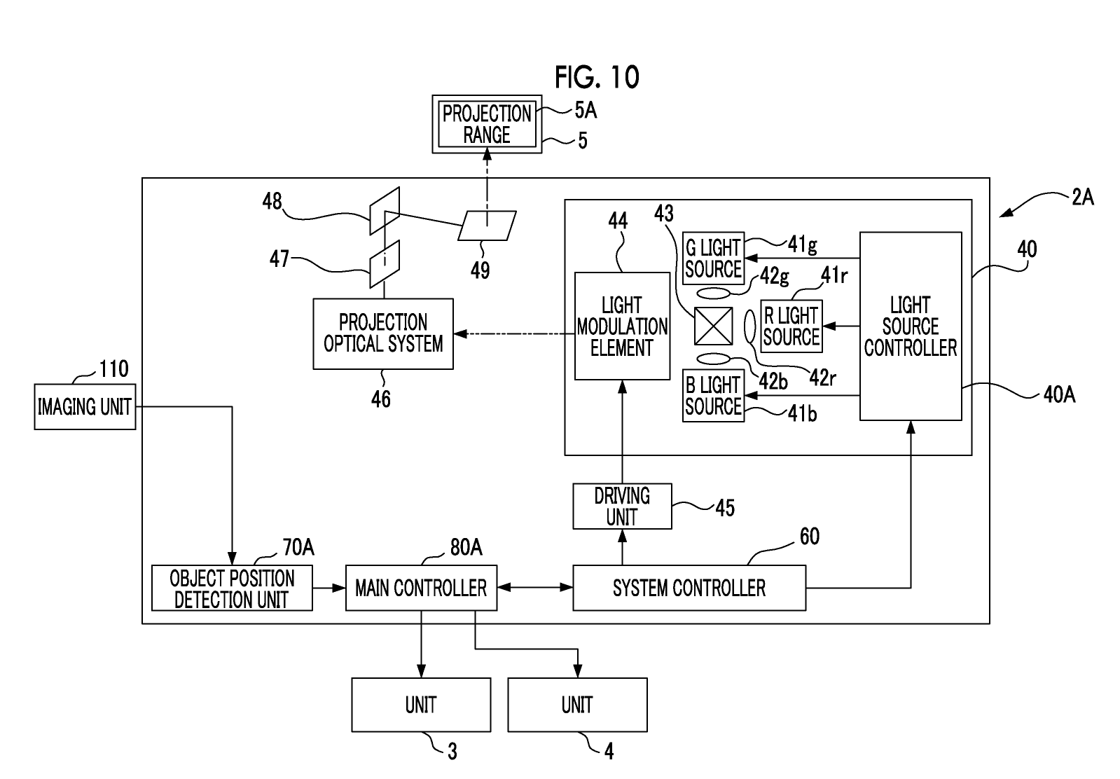

FIG. 10 is a schematic diagram showing an internal configuration of the unit 2A of the HUD 10A mounted in the construction machine 100A shown in FIG. 9. In FIG. 10, the same components as in FIG. 3 are given the same reference numerals. The unit 2A is obtained by modifying the main controller 80 into a main controller 80A, and modifying the object position detection unit 70 into an object position detection unit 70A.

The object position detection unit 70A detects the position of a movable part (the bucket 22) of the construction machine 100 as a first object, and detects the position of an object other than the movable part (for example, a human, an obstacle, or the like) as a second object.

The object position detection unit 70A acquires captured image data obtained using the imaging unit 110, and detects the position of the first object and the position of the second object using a known image recognition process, on the basis of the acquired captured image data.

The main controller 80A has the following functions, in addition to the functions of the main controller 80 of the HUD 10. That is, in a case where it is determined that the second object enters a projection range of image light based on a projection display unit that is controlled in a projection-off-state, the main controller 80 controls the projection display unit into a projection-on-state.

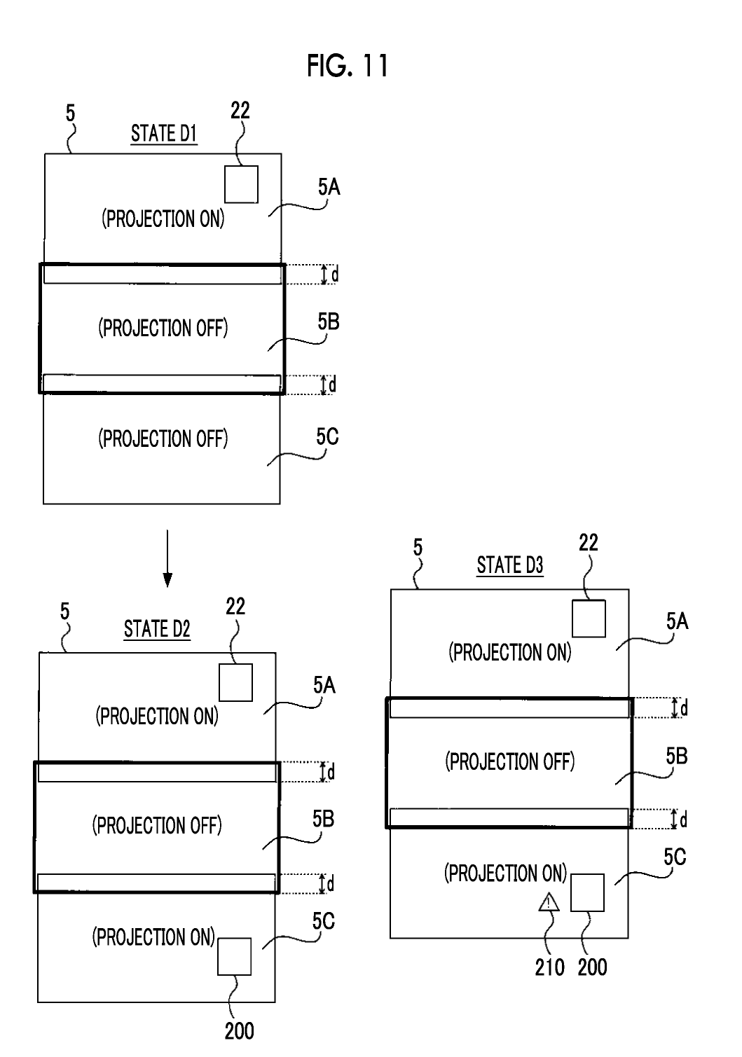

Next, a processing example in a case where the second object is detected in the projection range of the image light in the projection display unit that is controlled in the projection-off-state will be described with reference to FIG. 11.

FIG. 11 is a schematic diagram illustrating an example of state transition of the range 5D in the HUD 10A.

The range 5D is the same as in FIG. 6, in which end portions of the first projection range 5A and the second projection range 5B that are adjacent to each other overlap each other, and end portions of the second projection range 5B and the third projection range 5C that are adjacent to each other overlap each other.

In FIG. 11, a range where the first projection range 5A and the second projection range 5B overlap each other and a range where the second projection range 5B and the third projection range 5C overlap each other are represented as an overlapping range d, respectively.

In a state D1, since the entirety of the bucket 22 is present in the first projection range 5A and the bucket 22 is out of the overlapping range d, only the projection display unit corresponding to the first projection range 5A is controlled into the projection-on-state.

The state D1 transits to a state D2, and an object 200 other than the bucket 22 is detected by the object position detection unit 70A. In a case where the object 200 is detected, the main controller 80A determines whether at least a part of the object 200 enters any one of the second projection range 5B or the third projection range 5C corresponding to the projection display units that are controlled in the projection-off-state.

In the state D2, since the object 200 enters the third projection range 5C, the main controller 80A determines that at least a part of the object 200 enters the third projection range 5C, and controls the projection display unit corresponding to the third projection range 5C into the projection-on-state. Further, the main controller 80A generates projection image data including information to be notified to an operator (for example, an icon or the like for warning danger in a case where the object 200 is a human) according to details of the detected object 200, and transmits the result to the system controller 62 of the unit 4.

Thus, image light based on the projection image data is projected onto the third projection range 5C from the unit 4, and a warning icon 210 is displayed as a virtual image in the vicinity of the object 200 in the third projection range 5C (state D3).

As described above, according to the HUD 10A, even in a projection display unit that is controlled in the projection-off-state, in a case where an object is detected in a projection range corresponding to the projection display unit, it is possible to operate the projection display unit. Thus, an operator can easily recognize a human, an obstacle or the like other than the bucket 22. Further, it is possible to cause the operator to recognize danger or the like due to the object using the warning icon 210, and to achieve accurate working assistance while achieving power saving.

As described above, the following configurations are disclosed in this specification.

A disclosed projection type display device includes a plurality of projection display units capable of spatially modulating light emitted from a light source on the basis of image information and projecting the spatially modulated image light onto a projection surface of a vehicle, in which respective projection ranges of image light of the plurality of projection display units are arranged in one direction, and an end of one projection range among two adjacent projection ranges in the one direction and the other projection range among the two projection ranges overlap each other. The projection type display device includes: an object position detection unit that detects a position, on the projection surface, of an object in front of the projection surface; and a unit controller that controls each of the plurality of projection display units into any one of a first state where image light is to be projected or a second state where projection of image light is stopped, in which the unit controller controls each of the plurality of projection display units into any one of the first state or the second state on the basis of the position, in the one direction, of a first object detected by the object position detection unit.

The disclosed projection type display device is configured so that in a state where a first projection range that is an arbitrary projection range among the respective projection ranges of image light of the plurality of projection display units and the entirety of the first object detected by the object position detection unit overlap each other, the unit controller may selectively perform any one of a first control or a second control on the basis of the position, in the one direction, of the first object in the first projection range, the first control may be a control for controlling a first projection display unit capable of projecting image light onto the first projection range into the first state and controlling a projection display unit other than the first projection display unit into the second state, and the second control may be a control for controlling the first projection display unit and a second projection display unit capable of projecting image light onto a projection range adjacent to the first projection range into the first state and controlling a projection display unit other than the first projection display unit and the second projection display unit into the second state.

The disclosed projection type display device is configured so that the unit controller may perform the second control using a projection display unit capable of projecting image light onto an adjacent projection range on the side of the first projection range close to the first object as the second projection display unit in a case where a range corresponding to a predetermined distance from an end of the first projection range in the one direction and the first object overlap each other, and may perform the first control in a case where the first object is present outside the range corresponding to the predetermined distance from the end of the first projection range in the one direction.

The disclosed projection type display device is configured so that the end of the one projection range of the two adjacent projection ranges in the one direction may be brought into contact with an end of the other projection range among the two projection ranges in the one direction.

The disclosed projection type display device is configured so that the two adjacent projection ranges in the one direction may have end portions that overlap each other in the one direction.

The disclosed projection type display device is configured so that in a case where the position of a second object different from the first object is detected by the object position detection unit and the second object is present in a projection range of image light in a projection display unit that is controlled in the second state, the unit controller may control the projection display unit into the first state.

The disclosed projection type display device is configured so that the object position detection unit may detect the position of an object on the basis of captured image data obtained by imaging the projection surface using an imaging element.

The disclosed projection type display device is configured so that the one direction may be a gravity direction.

The disclosed projection type display device is configured so that the vehicle may be a construction machine.

The disclosed projection type display device is configured so that the construction machine may perform construction work using a movable part capable of being moved in the one direction, and the object position detection unit may detect the position of the movable part as the position of the first object.

The disclosed projection type display device is configured so that the movable part may be a bucket.

A disclosed projection control method uses a plurality of projection display units capable of spatially modulating light emitted from a light source on the basis of image information and projecting the spatially modulated image light onto a projection surface of a vehicle, in which respective projection ranges of image light of the plurality of projection display units are arranged in one direction, and an end of one projection range among two adjacent projection ranges in the one direction and the other projection range among the two projection ranges overlap each other. The projection control method includes: an object position detection step of detecting a position, on the projection surface, of an object in front of the projection surface; and a unit control step of controlling each of the plurality of projection display units into any one of a first state where image light is to be projected or a second state where projection of image light is stopped, in which the unit control step includes controlling each of the plurality of projection display units into any one of the first state or the second state on the basis of the position, in the one direction, of a first object detected in the object position detection step.

The disclosed projection control method is configured so that the unit control step may include selectively performing any one of a first control or a second control on the basis of the position, in the one direction, of the first object in the first projection range in a state where a first projection range that is an arbitrary projection range among the respective projection ranges of image light of the plurality of projection display units and the entirety of the first object detected in the object position detection step overlap each other, the first control may be a control for controlling a first projection display unit capable of projecting image light onto the first projection range into the first state and controlling a projection display unit other than the first projection display unit into the second state, and the second control may be a control for controlling the first projection display unit and a second projection display unit capable of projecting image light onto a projection range among projection ranges adjacent to the first projection range into the first state and controlling a projection display unit other than the first projection display unit and the second projection display unit into the second state.

The disclosed projection control method is configured so that the unit control step may include performing the second control using a projection display unit capable of projecting image light onto an adjacent projection range on the side of the first projection range close to the first object as the second projection display unit in a case where a range corresponding to a predetermined distance from an end of the first projection range in the one direction and the first object overlap each other, and performing the first control in a case where the first object is present outside the range corresponding to the predetermined distance from the end of the first projection range in the one direction.

The disclosed projection control method is configured so that the end of the one projection range of the two adjacent projection ranges in the one direction may be brought into contact with an end of the other projection range among the two projection ranges in the one direction.

The disclosed projection control method is configured so that the two adjacent projection ranges in the one direction may have end portions that overlap each other in the one direction.

The disclosed projection control method is configured so that the unit control step may include controlling, in a case where the position of a second object different from the first object is detected in the object position detection step and the second object is present in a projection range of image light in a projection display unit that is controlled in the second state, the projection display unit into the first state.

The disclosed projection control method is configured so that the object position detection step may include detecting the position of an object on the basis of captured image data obtained by imaging the projection surface using an imaging element.

The disclosed projection control method is configured so that the one direction may be a gravity direction.

The disclosed projection control method is configured so that the vehicle may be a construction machine.

The disclosed projection control method is configured so that the construction machine may perform construction work using a movable part capable of being moved in the one direction, and the object position detection step may include detecting the position of the movable part as the position of the first object.

The disclosed projection control method is configured so that the movable part may be a bucket.

The invention is particularly applied to a working machine, such as a construction machine or an agricultural machine, which provides high comfort and effectiveness.

### EXPLANATION OF REFERENCES

2, 3, 4: unit
5: windshield
10, 10A: HUD
40: light source unit
45: driving unit
60, 61, 62: system controller
70: object position detection unit
80: main controller
100, 100A: construction machine

What is claimed is:

1. A projection type display device that includes a plurality of projection display units capable of spatially modulating light emitted from a light source on the basis of image information and projecting the spatially modulated image light onto a projection surface of a vehicle,
wherein respective projection ranges of image light of the plurality of projection display units are arranged in one direction, and an end of one projection range among two adjacent projection ranges in the one direction and the other projection range among the two projection ranges overlap each other,
the projection type display device comprising:
an object position detection unit that detects a position, on the projection surface, of an object in front of the projection surface; and
a unit controller that controls each of the plurality of projection display units into any one of a first state where image light is to be projected or a second state where projection of image light is stopped,
wherein the unit controller controls each of the plurality of projection display units into any one of the first state or the second state on the basis of the position, in the one direction, of a first object detected by the object position detection unit,
wherein in a state where a first projection range that is an arbitrary projection range among the respective projection ranges of image light of the plurality of projection display units and the entirety of the first object detected by the object position detection unit overlap each other, the unit controller selectively performs any one of a first control or a second control on the basis of the position, in the one direction, of the first object in the first projection range,
wherein the first control is a control for controlling a first projection display unit capable of projecting image light onto the first projection range into the first state and controlling a projection display unit other than the first projection display unit into the second state, and
wherein the second control is a control for controlling the first projection display unit and a second projection display unit capable of projecting image light onto a projection range adjacent to the first projection range into the first state and controlling a projection display unit other than the first projection display unit and the second projection display unit into the second state.

2. The projection type display device according to claim 1,
wherein the unit controller performs the second control using a projection display unit capable of projecting image light onto an adjacent projection range on the side of the first projection range close to the first object as the second projection display unit in a case where a range corresponding to a predetermined distance from an end of the first projection range in the one direction and the first object overlap each other, and performs the first control in a case where the first object is present outside the range corresponding to the predetermined distance from the end of the first projection range in the one direction.

3. The projection type display device according to claim 1,
wherein the end of the one projection range of the two adjacent projection ranges in the one direction is brought into contact with an end of the other projection range among the two projection ranges in the one direction.

4. The projection type display device according to claim 1,
wherein the two adjacent projection ranges in the one direction have end portions that overlap each other in the one direction.

5. The projection type display device according to claim 1,
wherein in a case where the position of a second object different from the first object is detected by the object position detection unit and the second object is present in a projection range of image light in a projection display unit that is controlled in the second state, the unit controller controls the projection display unit into the first state.

6. The projection type display device according to claim 5,
wherein the object position detection unit detects the position of an object on the basis of captured image data obtained by imaging the projection surface using an imaging element.

7. The projection type display device according to claim 1,
wherein the one direction is a gravity direction.

8. The projection type display device according to claim 1,
wherein the vehicle is a construction machine.

9. The projection type display device according to claim 8,
wherein the construction machine performs construction work using a movable part capable of being moved in the one direction, and
the object position detection unit detects the position of the movable part as the position of the first object.

10. The projection type display device according to claim 9,
wherein the movable part is a bucket.

11. A projection control method using a plurality of projection display units capable of spatially modulating light emitted from a light source on the basis of image information and projecting the spatially modulated image light onto a projection surface of a vehicle,
wherein respective projection ranges of image light of the plurality of projection display units are arranged in one direction, and an end of one projection range among two adjacent projection ranges in the one direction and the other projection range among the two projection ranges overlap each other,
the projection control method comprising:
an object position detection step of detecting a position, on the projection surface, of an object in front of the projection surface; and
a unit control step of controlling each of the plurality of projection display units into any one of a first state where image light is to be projected or a second state where projection of image light is stopped,
wherein the unit control step includes controlling each of the plurality of projection display units into any one of the first state or the second state on the basis of the position, in the one direction, of a first object detected in the object position detection step,
wherein the unit control step includes selectively performing any one of a first control or a second control on the basis of the position, in the one direction, of the first object in the first projection range in a state where a first projection range that is an arbitrary projection range among the respective projection ranges of image light of the plurality of projection display units and the entirety of the first object detected in the object position detection step overlap each other,
wherein the first control is a control for controlling a first projection display unit capable of projecting image light onto the first projection range into the first state and controlling a projection display unit other than the first projection display unit into the second state, and
wherein the second control is a control for controlling the first projection display unit and a second projection display unit capable of projecting image light onto a projection range among projection ranges adjacent to the first projection range into the first state and controlling a projection display unit other than the first projection display unit and the second projection display unit into the second state.

12. The projection control method according to claim 11,
wherein the unit control step includes performing the second control using a projection display unit capable of projecting image light onto an adjacent projection range on the side of the first projection range close to the first object as the second projection display unit in a case where a range corresponding to a predetermined distance from an end of the first projection range in the one direction and the first object overlap each other, and performing the first control in a case where the first object is present outside the range corresponding to the predetermined distance from the end of the first projection range in the one direction.

13. The projection control method according to claim 11,
wherein the end of the one projection range of the two adjacent projection ranges in the one direction is brought into contact with an end of the other projection range among the two projection ranges in the one direction.

14. The projection control method according to claim 11,
wherein the two adjacent projection ranges in the one direction have end portions that overlap each other in the one direction.

15. The projection control method according to claim 11,
wherein the unit control step includes controlling, in a case where the position of a second object different from the first object is detected in the object position detection step and the second object is present in a projection range of image light in a projection display unit that is controlled in the second state, the projection display unit into the first state.

16. The projection control method according to claim 15,
wherein the object position detection step includes detecting the position of an object on the basis of captured image data obtained by imaging the projection surface using an imaging element.

17. The projection control method according to claim 11,
wherein the one direction is a gravity direction.

18. The projection control method according to claim 11,
wherein the vehicle is a construction machine.

19. The projection control method according to claim 18,
wherein the construction machine performs construction work using a movable part capable of being moved in the one direction, and
the object position detection step includes detecting the position of the movable part as the position of the first object.

20. The projection control method according to claim 19,
wherein the movable part is a bucket.
